(19) United States
(12) Patent Application Publication
(10) Pub. No.: US 2014/0316783 A1
(43) Pub. Date: Oct. 23, 2014

(54) VOCAL KEYWORD TRAINING FROM TEXT

(71) Applicant: Eitan Asher Medina, Palo Alto, CA (US)

(72) Inventor: Eitan Asher Medina, Palo Alto, CA (US)

(21) Appl. No.: 14/249,255

(22) Filed: Apr. 9, 2014

Related U.S. Application Data
(60) Provisional application No. 61/814,119, filed on Apr. 19, 2013.

(51) Int. Cl. G10L 17/04

(52) U.S. Cl. CPC G10L 17/04
USPC 704/244

(57) ABSTRACT

Systems and methods for vocal keyword training from text are provided. In one example method, text is received via keyboard or a touch screen. The text can include one or more words of language known to a user. The received text can be compiled to generate a signature. The signature can embody a spoken keyword and include a sequence of phonemes or a triphone. The signature can be provided as an input to automatic speech recognition (ASR) software for subsequent comparison to an audible input. In various embodiments, a mobile device receives the audible input and the text, and at least one of the compiling and ASR functionality is distributed to a cloud-based system.

### CROSS-REFERENCE TO RELATED APPLICATION

The present application claims the benefit of U.S. Provisional Application No. 61/814,119, filed on Apr. 19, 2013. The subject matter of the aforementioned application is incorporated herein by reference for all purposes.

### FIELD

The present application relates generally to user authentication and, more specifically, to training a computing device to authenticate a user.

### BACKGROUND

Authentication is a process of determining whether someone is who he or she purports to be. Authentication is important for protecting information and/or data and services from unintended and/or unauthorized access, modification, or destruction. One authentication technique relies on audible input and automatic speech recognition (ASR). Authentication is important for protecting information and needs to be sufficiently accurate to protect sensitive information/data and services.

Voice-user interfaces (VUIs) also rely on audible input and ASR to initiate an automated service or process, e.g., to control a computing device. The VUIs need to respond to input reliably or they will be rejected by users.

Methods relying on audible input and ASR, e.g., a spoken/vocal keyword, have various issues. For example, in training, an initial entry of the spoken keyword can require a controlled environment (e.g., a quiet environment with the user in proximity of a computing device). Absent the controlled environment, errors from environmental noise can result. The training can also require recording and storing the keyword.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to an example embodiment, a system for vocal keyword for training a computing device from text can include a text input device, one or more hardware processors and a memory communicatively coupled thereto. The memory may be configured to store instructions, including a text input module, a text compiler module, and a voice recognition module. The text input module can be configured to receive text via the text input device. The text can include an actual or virtual keyword. In some embodiments, the text may include one or more words of a language known to the user. In other embodiments, the text can include a keyword selected from a list.

In some embodiments, the text compiler module compiles the text to generate a signature. The signature can embody a spoken keyword. The signature can include a sequence of phonemes, triphone, and the like. The voice recognition module can store the signature for subsequent comparison with audible input.

The exemplary system for vocal keyword training a computing device from text may include one or more microphones. The voice recognition module may be configured to receive, via the one or more microphones, an audible input and compare the audible input to the stored signature.

According to further embodiments, a computing device, like a mobile phone, netbook, and the like, includes one or more microphones and a text input device. The computing devices can be connected via a network to a computing cloud. The computing cloud can be configured to store and execute instructions of the text compiler module and the voice recognition module. The computing device may receive text and request a compilation of the text in the computing cloud.

According to another example embodiments of the present disclosure, the method steps are stored on a machine-readable medium comprising instructions, which when implemented by one or more processors perform the recited steps.

### BRIEF DESCRIPTION OF THE DRAWINGS

Embodiments are illustrated by way of example and not limitation in the figures of the accompanying drawings, in which like references indicate similar elements and in which:

FIG. 1 is an example environment in which a method for vocal keyword training from a text can be practiced.

FIG. 2 is a block diagram of a computing device that can implement a method for vocal keyword training from a text, according to an example embodiment.

FIG. 3 is a block diagram showing components of an exemplary application for vocal keyword training from text.

FIG. 4 is a flow chart illustrating a method for vocal keyword training from text, according to an example embodiment.

FIG. 5 is example of a computer system implementing a method for vocal keyword training from text.

### DETAILED DESCRIPTION

The present disclosure provides example systems and methods for vocal keyword training from text. Embodiments of the present disclosure can be practiced on a computing device, for example, notebook computers, tablet computers, phablets, smart phones, hand-held devices, such as wired and/or wireless remote controls, personal digital assistants, media players, mobile telephones, wearables, and the like. The computing devices can be used in stationary and mobile environments. Stationary environments can be residential and commercial buildings or structures. Stationary environments, for example, can include living rooms, bedrooms, home theaters, conference rooms, auditoriums, and the like. For mobile environments, the systems can be moving in a vehicle, carried by a user, or be otherwise transportable.

According to an example embodiment, a method for vocal keyword training of a computing device from text includes receiving text. The method can include compiling text into a signature. The signature can embody a spoken keyword and include, for example, a sequence of phonemes. The method can further proceed with storing the signature. The method can also include receiving an audible input and comparing the signature to the audible input.

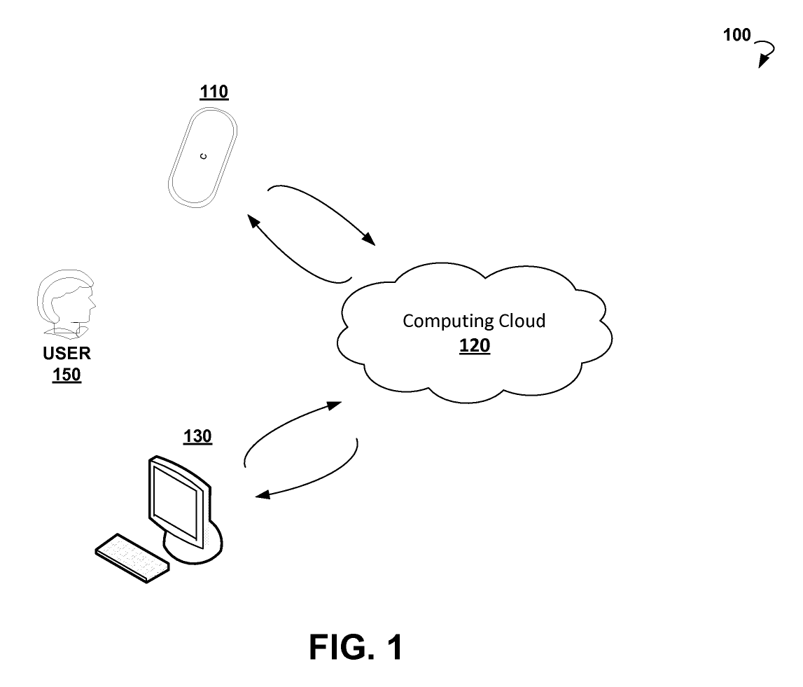

Referring now to FIG. 1, an environment 100 is shown in which a method for vocal keyword training from text can be practiced. In some embodiments, a mobile device 110 is configurable to receive text input from a user 150, process the text input, and store the result. The mobile device 110 can be connected to a computing cloud 120, via a network, in order for the mobile device 110 to send and receive data such as, for example, text, as well as request computing services, such as, for example, text processing, and receive the result of the computation. The result of the text processing can be available on another computing device, for example, a computer system 130 connected to the computing cloud 120 via a network.

The mobile device 110 and/or computer system 130 may be operable to receive an acoustic sound from the user 150. The acoustic sound can be contaminated by a noise. Noise sources can include street noise, ambient noise, sound from the mobile device such as audio, speech from entities other than an intended speaker(s), and the like.

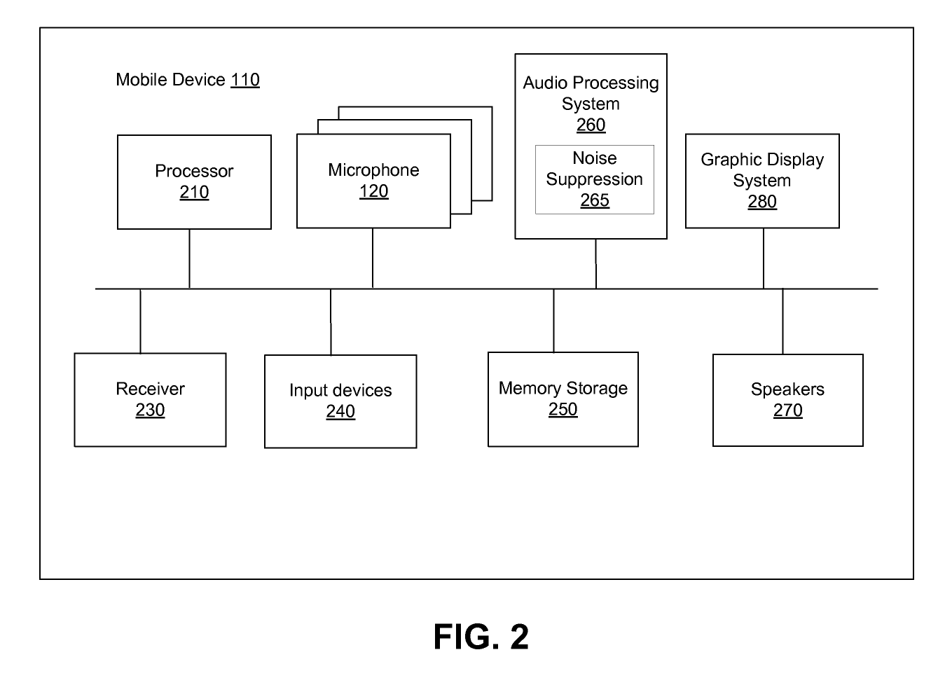

FIG. 2 is a block diagram showing components of an exemplary mobile device 110. FIG. 2 provides exemplary details of the mobile device 110 of FIG. 1. In the illustrated embodiment, the mobile device 110 includes a processor 210, one or more microphones 220, a receiver 230, input devices 240, memory storage 250, an audio processing system 260, speakers 270, and graphic display system 280. The mobile device 110 can include additional or other components necessary for mobile device 110 operations. Similarly, the mobile device 110 can include fewer components that perform similar or equivalent functions to those depicted in FIG. 2.

The processor 210 can include hardware and/or software, which is operable to execute computer programs stored in a memory storage 250. The processor 210 can use floating point operations, complex operations, and other operations, including vocal keyword training a mobile device from text. In some embodiments, the processor 210 of the mobile device can, for example, comprise at least one of a digital signal processor, image processor, audio processor, general-purpose processor, and the like.

The graphic display system 280 can be configured to provide a graphic user interface. In some embodiments, a touch screen associated with the graphic display system 280 can be utilized to receive text input from a user via a virtual keyboard. Options can be provided to a user via icon or text buttons in response to the user touching the screen.

The input devices 240 can include an actual keyboard for inputting text. In some embodiments, the actual keyboard can be an external device connected to the mobile device 110.

The audio processing system 260 can be configured to receive acoustic signals from an acoustic source via the one or more microphones 220 and process the acoustic signals' components. The microphones 220 can be spaced a distance apart such that acoustic waves impinging on the device from certain directions exhibit different energy levels at the one or more microphones. After receipt by the microphones 220, the acoustic signals can be converted into electric signals. These electric signals can, in turn, be converted by an analog-to-digital converter (not shown) into digital signals for processing in accordance with some embodiments. The processed audio signal can be transmitted for further processing to the processor 210 and/or stored in memory storage 250.

In various embodiments, where the microphones 220 include omni-directional microphones that are closely spaced (e.g., 1-2 cm apart), a beamforming technique can be used to simulate a forward-facing and a backward-facing directional microphone response. A level difference can be obtained using the simulated forward-facing and the backward-facing directional microphone. The level difference can be used to discriminate speech and noise in, for example, the time-frequency domain, which can be used in noise and/or echo reduction. In some embodiments, some microphone(s) can be used mainly to detect speech and other microphone(s) can used mainly to detect noise. In various embodiments, some microphones can be used to detect both noise and speech.

In some embodiments, in order to suppress the noise, an audio processing system 260 can include a noise suppression module 265. The noise suppression can be carried out by the audio processing system 260 and noise suppression module 265 of the mobile device 110 based variously on level difference (for example, inter-microphone level difference (ILD)), level salience, pitch salience, signal type classification, speaker identification, and so forth. An example audio processing system suitable for performing noise reduction is discussed in more detail in U.S. patent application Ser. No. 12/832,901, titled “Method for Jointly Optimizing Noise Reduction and Voice Quality in a Mono or Multi-Microphone System”, filed on Jul. 8, 2010, the disclosure of which is incorporated herein by reference for all purposes.

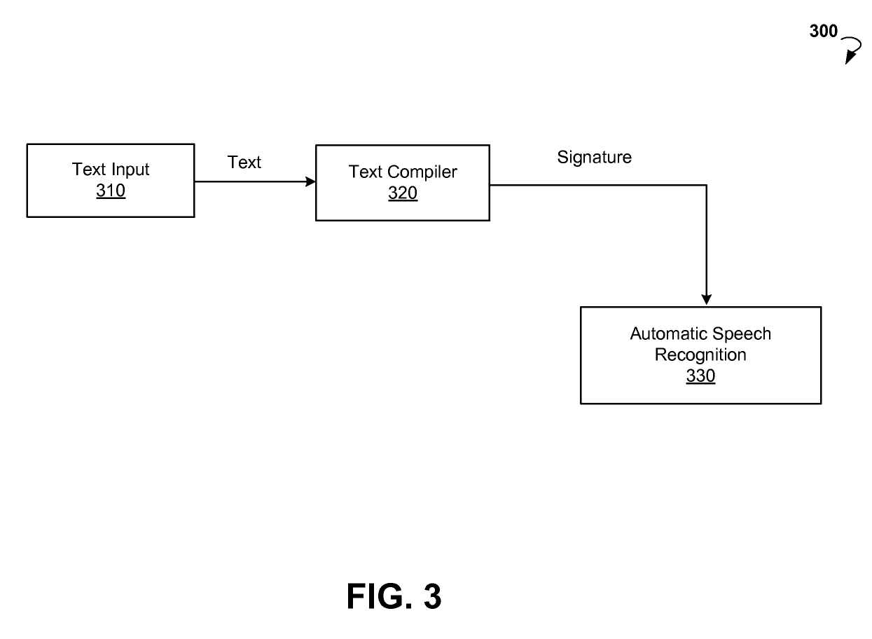

In some embodiments, a computing device, for example the mobile device 110, can include an application module 300 that a user can invoke or launch, for example, an application facilitating keyword training. FIG. 3 is a block diagram showing components of application module 300 for keyword training from text, according to an example embodiment. The application module 300 can include a text input (module) 310, a text compiler (module) 320, and automatic speech recognition (ASR) module 330. In some embodiments, the modules 310, 320, and 330 can be implemented as instructions stored in memory and can be executed by a local processor of the computing device. In other embodiments, the instructions of modules 310, 320, and 330 can be carried out by one or more remote processors communicatively coupled to the computing device.

Upon being invoked in response to touching, gesturing on, or otherwise actuating a screen, e.g., pressing an icon or button, the application module 300 (also referred to herein as the keyword training application module 300) can perform the following steps. As would be readily understood by one of ordinary skill in the art, in various embodiments all or some of the following steps in different combinations (or permutations) can be performed, and the order in which the steps are performed may vary from an order illustrated below.

Text representing the audible input can be received by the computing device. The text can, for example, be input by the user through an actual keyboard and/or a virtual keyboard, for example, displayed on a touch screen associated with the computing device. The text may also be displayed and/or edited on the computing device using, for example, a text editor. The text may further embody one or more words of a language known to the user and/or for which the computing device is configured to receive input. Alternatively or in addition, the text can, for example, be capable of expression by a series and/or combination(s) of characters/symbols of the actual and/or virtual keyboard. In various embodiments, the text can include a user-selectable keyword having an associated audible, for example, spoken or vocal expression of textual representation of the audible input.

In response to receiving the text, a local processor of the computing device, for example, processor 210 of the mobile device 110, and/or a remote processor communicatively coupled to the computing device can compile the text using to a signature instruction of text compiler module 320. The signature can be provided to a voice recognition module, for example the ASR module 330. The text may be included in a text file produced by the text editor. In some embodiments, the local and/or remote processor can compile the text into an input for automatic speech recognition (ASR) module 330. The input for ASR can “match” or correspond to the text, in various embodiments. For example, the compiler can convert the text into a representation of its associated audible expression.

In various embodiments, the compiler generates a sequence of phonemes based at least in part on the text. The phoneme sequence may be derived from a language associated with the text. A phoneme can, for example, include a basic unit of a language's phonology, which may be combined with other phonemes to form meaningful units such as words or morphemes. Phonemes can be used as building blocks for storing spoken keywords. By way of example and not limitation, a user can enter “Hi earsmart,” and since the text editor is using a known language, the phoneme compiler can translate it to a correct phoneme sequence: /h/ /ī/ //i/ /e/ /r/ /s/ /m/ /a(r)/ /t/. As would be readily appreciated by one of ordinary skill in the art, other variations of phoneme-based sequences can be used, such as, for example, triphones.

In response to compiling the text, the input for ASR can be provided to ASR module 330. In some embodiments, ASR produces and/or stores a signature of the keyword for subsequent matching with audible input. For example, a keyword recognizer can store the phoneme sequence for later matching. Once the keyword is stored, the computing device can be said to be trained for the keyword. The computing device may be trained for more than one keyword and the associated keyword signatures can be stored, for example, in a local (or remote) data store or database.

In various embodiments, the computing device can receive audible input. The audible input can be manipulated, for example, digitized, filtered, noise-reduced, and the like. The received audible input can be used to separate noise from clean vocal signal, in some embodiments, and the clean vocal signal can be provided to ASR module 330. ASR can be operable determine that the (manipulated) audible input matches/conforms to a signature of a keyword compiled from the text, for example, by comparing the (manipulated) audible input to the keyword. The determination of a match or no match can be used, for example, to authenticate the user and/or control the computing device, thus, the keyword can be a password and/or command.

As would be appreciated by one of ordinary skill in the art, the functions described above may be performed by one computing device or be distributed across multiple computing devices communicatively coupled, for example, by a network such as the Internet. By way of example and not limitation, one computing device can receive the audible input and the text, and the compiler and ASR, for example, voice/keyword recognition functions can be distributed to one or more further computing devices, for example, cloud-based computing devices.

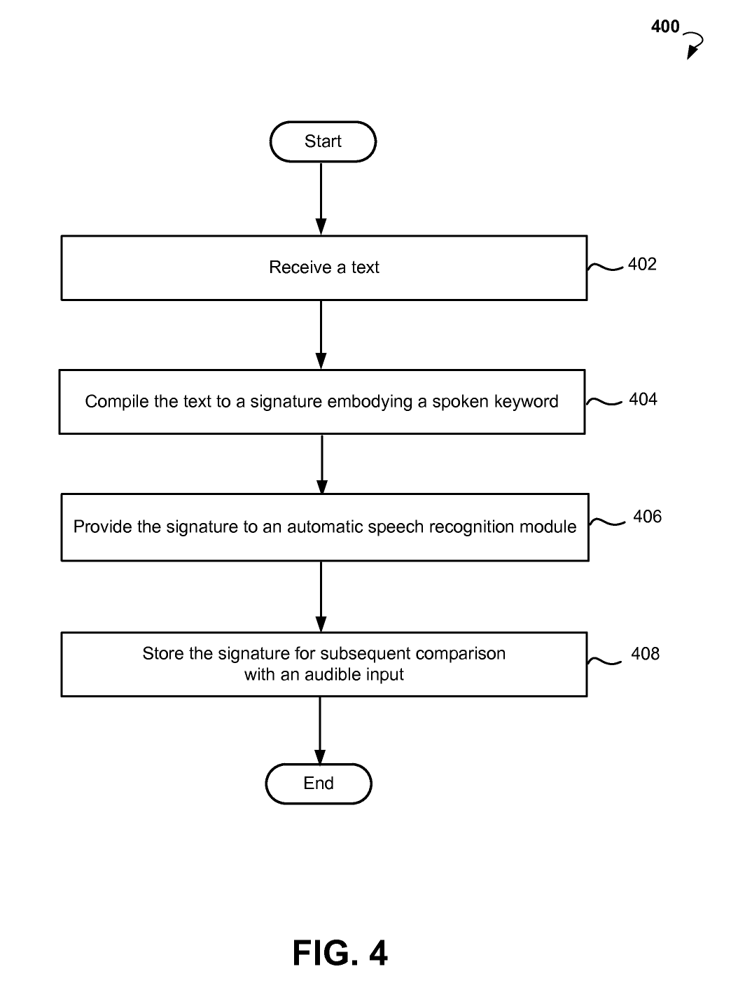

FIG. 4 is flow chart diagram showing steps of method 400 for vocal keyword training from text. The method 400 may commence in step 402 with receiving text. In step 404, the method 400 can continue with compiling the text to a signature embodying a spoken keyword. In step 406, the method 400 can proceed with providing the signature to an automatic speech recognition (ASR) module. In step 408, the method 400 can conclude with storing the voice input for subsequent comparison to an audible input. In some embodiments, the steps of the example method 400 can be carried out using the application module 300 (shown in FIG. 3).

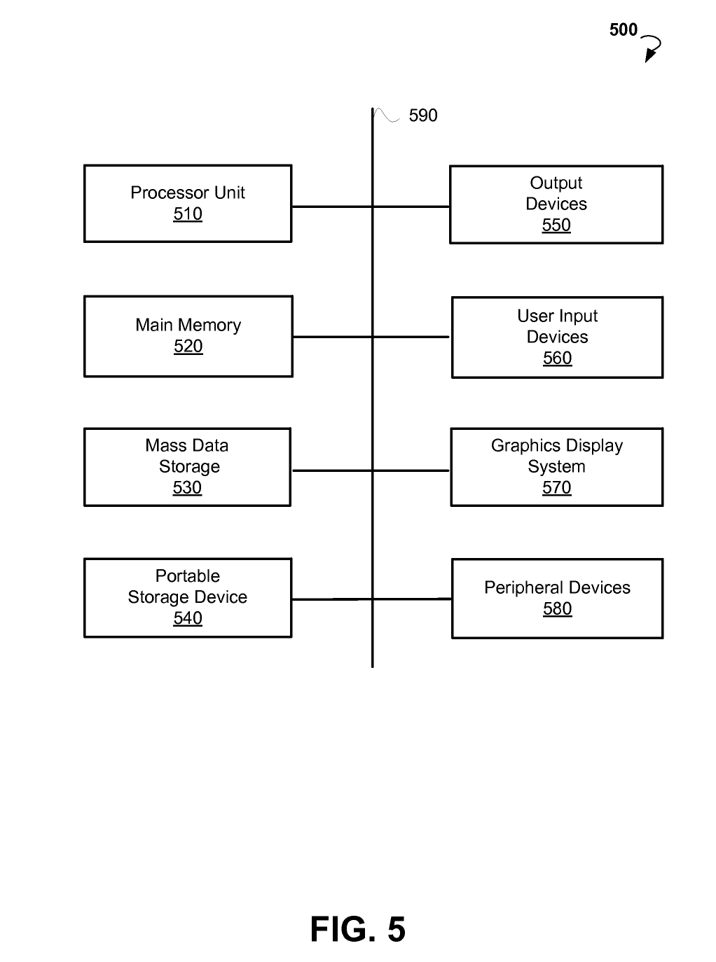

FIG. 5 illustrates an example computer system 500 that may be used to implement embodiments of the present disclosure. The system 500 of FIG. 5 can be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor units 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580. The methods may be implemented in software that is cloud-based.

The components shown in FIG. 5 are depicted as being connected via a single bus 590. The components may be connected through one or more data transport means. Processor unit 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Exemplary graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include flash memory, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), floppy disk, and/or any other memory chip, module, or cartridge.

In some embodiments, the computer system 500 may be implemented as a cloud-based computing environment, such as a virtual machine operating within a computing cloud. The computer system 500 may itself include a cloud-based computing environment, where the functionalities of the computer system 500 are executed in a distributed fashion. Thus, the computer system 500, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 500, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

While the present embodiments have been described in connection with a series of embodiments, these descriptions are not intended to limit the scope of the subject matter to the particular forms set forth herein. It will be further understood that the methods are not necessarily limited to the discrete components described. To the contrary, the present descriptions are intended to cover such alternatives, modifications, and equivalents as may be included within the spirit and scope of the subject matter as disclosed herein and defined by the appended claims and otherwise appreciated by one of ordinary skill in the art.

What is claimed is:

1. A method for vocal keyword training from text, the method comprising:
receiving the text;
compiling, using one or more hardware processors, the text to generate a signature, the signature embodying a spoken keyword; and
storing the signature for comparison to an audible input.

2. The method of claim 1, wherein the text includes one or more words of a pre-selected language.

3. The method of claim 1, wherein the text includes a keyword selected from a pre-determined list.

4. The method of claim 1, wherein the signature includes a sequence of phonemes.

5. The method of claim 1, wherein the signature includes a triphone.

6. The method of claim 1, further comprising:
receiving the audible input; and
comparing the audible input to the signature.

7. The method of claim 6, wherein the audible input is received using one or more microphones.

8. A system for vocal keyword training from text, the system comprising:
a text input module configured to be stored in memory and executable by one or more processors communicatively coupled to the memory, the text input module being operable to receive the text;
a text compiler module configured to be stored in the memory and executable by the one or more processors, the text compiler module being operable to compile the text and generate a signature, the signature embodying a spoken keyword; and
a voice recognition module configured to be stored in the memory and executable by the one or more processors, the voice recognition module being operable to store the signature for comparison to an audible input.

9. The system of claim 8, wherein the text includes one or more words of pre-selected language.

10. The system of claim 8, wherein the text includes a keyword from a pre-determined list.

11. The system of claim 8, wherein the signature includes at least one of a sequence of phonemes and a triphone.

12. The system of claim 8, wherein the text input module is operable in a mobile device and one of the text compiler module and the voice recognition module is operable in a cloud-based system and the other one of the text compiler module and the voice recognition module is operable in a mobile device.

13. The system of claim 8, wherein the text input module is operable in a mobile device and both of the text compiler module and the voice recognition module are operable in a cloud-based system.

14. The system of claim 8, further comprising one or more microphones, wherein the voice recognition module is configured to:
receive, via the one or more microphones, the audible input; and
compare the audible input to the signature.

15. A computer program product comprising a non-transitory computer-readable storage having embodied thereon instructions, which when executed using one or more hardware processors, perform a method for voice keyword training from text, the method comprising:
receiving the text;
compiling the text to generate a signature, the signature embodying a spoken keyword; and
storing the signature for comparison to an audible input.

16. The computer program product of claim 15, wherein the text includes one or more words of a pre-selected language.

17. The computer program product of claim 15, wherein the text includes a keyword selected from a pre-determined list.

18. The computer program product of claim 15, wherein the signature includes at least one of a sequence of phonemes and a triphone.

19. The computer program product of claim 18, wherein the text includes one or more words of a pre-selected language, the computer program product further comprising:
receiving the audible input; and
comparing the audible input to the signature,

20. The computer program product of claim 15, further comprising:
receiving, using one or more microphones, the audible input; and
comparing the audible input to the signature.
